(19) United States
(12) Patent Application Publication
(10) Pub. No.: US 2017/0102466 A1
(43) Pub. Date: Apr. 13, 2017

(54) SYSTEMS AND METHODS FOR SPACE-BASED GEOLOCATION OF VESSELS USING MARITIME SIGNALS TRANSMITTED THEREFROM

(71) Applicant: HARRIS CORPORATION, Melbourne, FL (US)

(72) Inventors: Eric Petkus, Palm Bay, FL (US); Timothy F. Dyson, Melbourne, FL (US); Jason Plew, Malabar, FL (US); Joshua P. Bruckmeyer, West Melbourne, FL (US); Charles Zahm, Indialantic, FL (US)

(21) Appl. No.: 14/879,135

(22) Filed: Oct. 9, 2015

(51) Int. Cl. G01S 19/46

(52) U.S. Cl. CPC G01S 19/46

(57) ABSTRACT

Systems (100) and methods (400) for space-based geolocation. The methods involve receiving by at least two first satellites a maritime signal transmitted from a vessel on or near Earth. The first satellites are deployed in space so as to have overlapping coverage areas. The maritime signal (received at the at least two first satellites) is then used to determine a geographic location of the vessel on Earth using at least one of a Time Difference of Arrival (“TDOA”) and a Frequency Difference of Arrival (“FDOA”).

### BACKGROUND OF THE INVENTION

Statement of the Technical Field

This document relates to maritime systems. More particularly, this document concerns systems and methods for space-based geolocation of vessels using maritime signals transmitted therefrom.

Description of the Related Art

Automatic Identification Systems (“AISs”) are well known in the art. The AISs typically allow vessels (e.g., ships) to view and track marine traffic in a surrounding area. AISs have many applications. For example, AISs can be employed for collision avoidance, fishing fleet monitoring and control, vessel traffic services, maritime security, navigation services, search and rescue, accident investigation, and fleet and cargo tracking

In this regard, an AIS is an automatic tracking system used on ships and by Vessel Traffic Services (“VTSs”) for identifying and locating vessels in a given geographic area or around the globe. A vessel's identification and location are tracked by exchanging data with other nearby vessels, AIS base stations and satellites. The vessel's identification and location are displayed in an AIS chartplotter or other Graphical User Interface (“GUI”) viewable on a display screen. The AIS chartplotter and other GUIs facilitate collision avoidance amongst a plurality of vessels in proximity to each other. Other information may also be displayed on the display screen, such as a vessel's position, course and/or speed.

The vessels comprise AIS transceivers which automatically and periodically transmit vessel information. The vessel information includes, but is not limited to, vessel name, position, speed and navigational status. The vessel information can be used to track the vessel by the AIS base stations and/or satellites. The AIS transceivers comprise a Very High Frequency (“VHF”) transceiver and a positioning system (e.g., a Global Positioning System (“GPS”)). The VHF transceiver has a VHF range of about 10-20 nautical miles. The VHF transceiver operates in accordance with a Time Division Multiple Access (“TDMA”) scheme. The AIS base stations and satellites comprise AIS receivers, and therefore can receive AIS data but are unable to transmit their own locations to the vessels. The AIS receivers also operate in accordance with the TDMA scheme.

The vessels and costal stations also have a Digital Selective Calling (“DSC”) capability. In this regard, each of the vessels and costal stations consists of a VHF DSC receiver. The VHF DSC receiver facilitates distress related communications over terrestrial marine radio systems. For example, in the event of an emergency, the VHF transmitter is used to instantly send an automatically formatted distress alert signal to coastal stations of rescue authorities anywhere in the world. The distress alert signal can include a priority designation specifying the priority level of the call, a vessel's address, a vessel's unique identifier, a vessel's position and the nature of the distress. In response to a reception of a distress alert signal, the coastal station immediately sends a DSC acknowledgement message to the vessel that transmitted the distress alert signal. The DSC acknowledgement message is received by the VHF DSC receiver. Thereafter, the AIS transceiver tunes to a designated channel for further distress related communications.

### SUMMARY OF THE INVENTION

This disclosure concerns systems and methods for space-based geolocation. The methods comprise receiving by at least two first satellites a maritime VHF signal transmitted from a vessel on or near Earth at a given time. The first satellites are deployed in space so as to have overlapping coverage areas. The maritime signal contains information specifying a vessel location. The maritime VHF signal includes, but is not limited to, an AIS signal, a DSC signal, or an Application Specific Messages (“ASM”) signal. The maritime VHF signal (received at the at least two first satellites) is then used to determine a reported vessel location and geographic location of the vessel on Earth. The geographic location is determined using at least one of a Time Difference of Arrival (“TDOA”) determined based on Time Of Arrival (“TOA”) measurements made by the first satellites and a Frequency Difference of Arrival (“FDOA”) determined based on Frequency of Arrival (“FOA”) measurements made by the first satellites.

In some scenarios, the geographic location is determined based on: a first TDOA measurement for the maritime signal received by the at least two first satellites during a first time period and a second TDOA measurement for the maritime signal received by the at least two first satellites during a second time period; a first FDOA measurement for the maritime signal received by the at least two first satellites during a first time period and a second FDOA measurement for the maritime signal received by the at least two first satellites during a second time period; a TDOA measurement for the maritime signal received by the at least two first satellites and a TDOA measurement for the maritime signal received by at least two second satellites; and/or an FDOA measured for the maritime signal received by the at least two first satellites and an FDOA measurement for the maritime signal received by at least two second satellites. The first and second satellites may include at least one same satellite and at least one different satellite.

In those or other scenarios, a reported vessel location is validated or invalidated. The (in)validation is achieved by comparing the geographic location with a vessel location specified by vessel location information contained in the maritime VHF signal. The reported vessel location is valid when the geographic location matches the vessel location specified by vessel location information contained in the maritime VHF signal to a first degree. The reported vessel location is invalid when the geographic location does not match the vessel location specified by vessel location information contained in the maritime VHF signal to a second degree. The first and second degrees can be the same or different. An entity (e.g., the coast guard, navy or drug enforcement agency) may be notified that the reported vessel location is valid or invalid based on results of the comparing.

### BRIEF DESCRIPTION OF THE DRAWINGS

Embodiments will be described with reference to the following drawing figures, in which like numerals represent like items throughout the figures, and in which:

FIG. 1 is an illustration of an exemplary system.

FIG. 2 is an illustration showing a vessel within the Field of View (“FOV”) of two satellites.

FIG. 3 is an illustration of an exemplary architecture for a space-borne maritime receiver.

FIG. 4 is a flow diagram of an exemplary method for geolocation.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

It should also be appreciated that the terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Further, unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present document generally concerns systems and methods for space-based geolocation of vessels using maritime VHF signals transmitted therefrom. The maritime VHF signals contain information specifying vessel locations. The maritime VHF signals include, but are not limited to, AIS signals, DSC signals, and/or ASM signals. The systems generally comprise maritime receivers deployed in space with satellites and ground equipment deployed on Earth. During operation, an AIS transceiver of a vessel transmits a maritime VHF signal including a vessel location. The maritime VHF signal is received by at least two of the maritime receivers deployed in space with overlapping coverage areas. The maritime receivers each comprise a processor (e.g., a low power processor). Each processor processes the received maritime VHF signal to determine a reported vessel location and geographic location of the vessel. The geographic location is determined using a Time Of Arrival (“TOA”) and/or a Frequency Of Arrival (“FOA”) of the maritime VHF signal. The manner in which the TOA and FOA are determined is described in detail below. A Time Difference Of Arrival (“TDOA”) is then determined using the TOAs from at least two satellites. Additionally or alternatively, a Frequency Difference Of Arrival (“FDOA”) is determined using the FOAs from at least two satellites. In some scenarios, the TDOA and FDOA are used together to provide accurate estimated locations for AIS transmitters on or near the Earth. By combining TDOA and FDOA measurements, instantaneous geolocation is performed in two dimensions, i.e., a time dimension and a frequency dimension. In some scenarios, the accurate estimated locations for the AIS transmitters are used to detect spoofing (i.e., a vessels reporting of a false location on or near Earth) and warn the appropriate authorities (e.g., the navy, coast guard, shipping companies or other entities).

The term “Time Of Arrival (TOA)”, as used herein, refers to the travel time a maritime VHF signal from an AIS transmitter to a remote maritime receiver. The term “Frequency Of Arrival (“FOA”)”, as used herein, refers to the frequency at which a maritime VHF signal is received by a remote maritime receiver. The term “Time Difference Of Arrival (“TDOA”)”, as used herein, refers to a measured time difference between the TOA determined at a first remote maritime receiver and the TOA determined at a second remote maritime receiver. The TDOA can be determined by computing the cross correlation between signals arriving at two maritime receivers. The TDOA estimate is taken as the delay, which maximized the cross correlation function. The term “Frequency Difference Of Arrival (“FDOA”)”, as used herein, refers to a measured frequency difference between the FOA determined at a first remote maritime receiver and the FOA determined at a second remote maritime receiver. Exemplary algorithms for determining a TDOA and an FDOA are discussed in detail below.

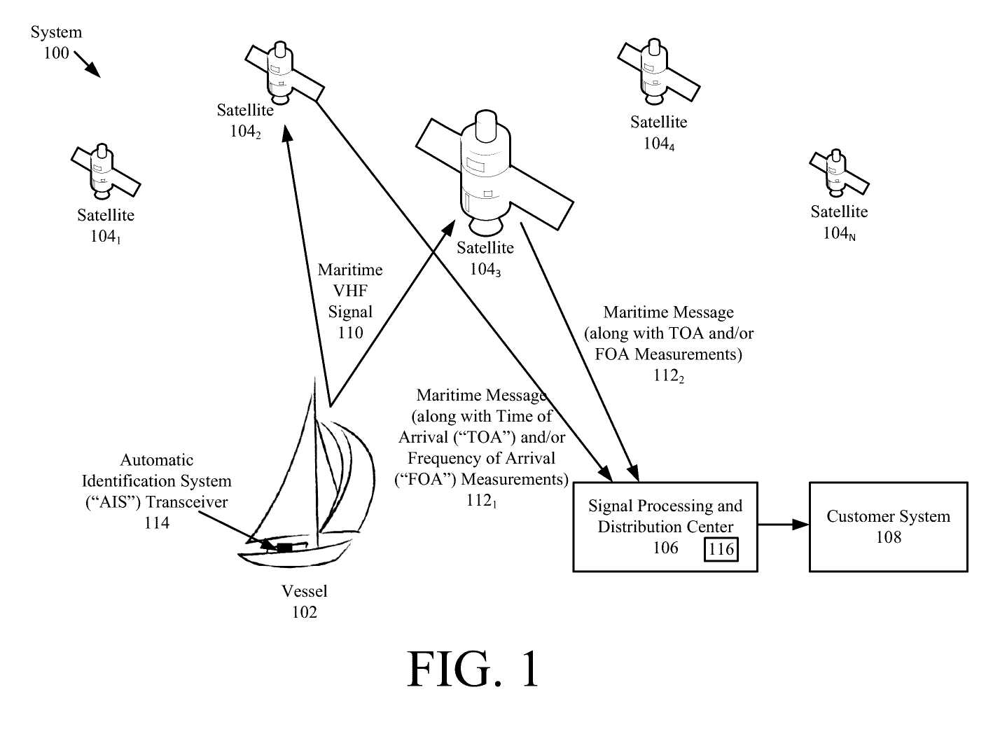

Referring now to FIG. 1, there is provided an illustration of an exemplary system 100. System 100 comprises a vessel 102, a plurality of satellites 104₁-104_{N}, a Signal Processing and Distribution Center (“SPDC”) 106, and a customer system 108. The satellites 104 collectively have a constellation architecture of N (e.g., 66) cross-linked Low-Earth Orbit (“LEO”) active satellites 104₁-104_{N} arranged in orbit so as to cover 100% of the globe. In some scenarios, the satellite constellation is an Iridium satellite constellation. Iridium satellite constellations are well known in the art, and therefore will not be described herein. Still, it should be understood that additional spare satellites (not shown) are provided to serve in case of failure. The satellites 104 communicate with neighboring satellites via inter-satellite links (e.g., via Kₐ band inter-satellite links). Each satellite 104 can have four inter-satellite links: two to neighbors fore and aft in the same orbital plane; and two to satellites in neighboring planes to either side. This is important because the present technique for determining a geolocation of a vessel is based on TOA and FOA information obtained by two or more satellites. In some scenarios, the processing of the TOAs and FOAs is performed by the satellites. This processing is facilitated by the satellites' ability to communicate information therebetween.

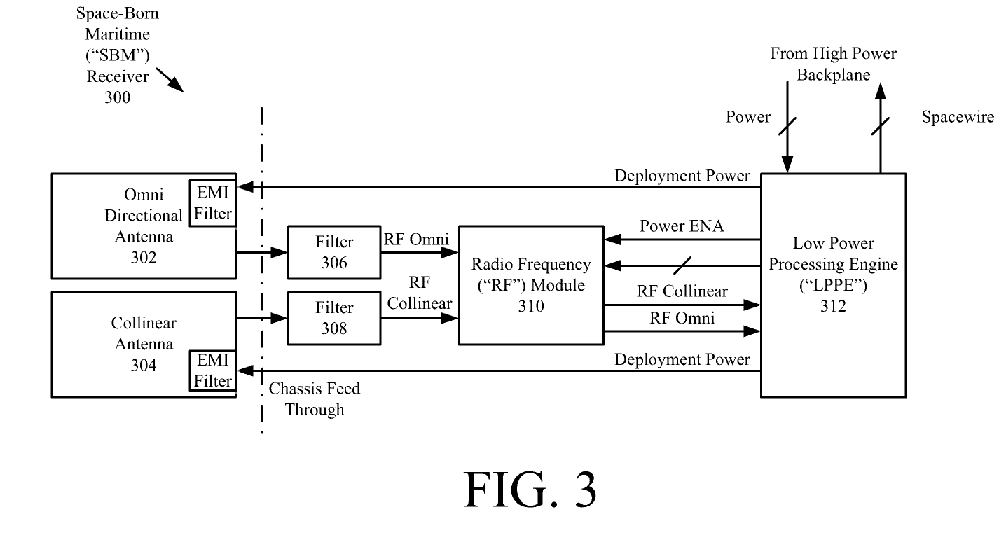

Each of the satellites 104 comprises a Space-Born Maritime (“SBM”) receiver. An exemplary architecture for an SBM receiver will be discussed in detail below in relation to FIG. 3. Still, it should be understood that the SBM receiver is configured to receive any signal in the marine VHF band (i.e., 156.025-162.025 MHz). As such, the satellites 104 provide a means for truly global communications at sea (even including the north/south pole areas of the globe), and also provide global persistence over the entire VHF maritime frequency band. Maritime communications are generally used for ship tracking in an AIS system. Since the satellites 104 comprise SBM receivers, the satellites can receive other VHF frequency bands in addition to those used in the AIS system.

The space-based receive capability facilitates the implementation of other maritime communication services within the system 100, such as a DSC service for distress related communications to and from terrestrial marine radio systems. The DSC service is a 24 hour, seven days of the week monitoring service. The DSC capability of the system 100 spans both the space segment (which includes the actual SBM receivers) where the DSC messages are received and also the ground segment (which includes the SPDC 106) where the DSC messages are processed. Additionally, the DSC capability of system 100 is a truly global, real-time DSC capability. Such a truly global, real-time DSC capability is not provided by conventional DSC systems. The term “real-time, as used herein, means either simultaneously, immediately, or promptly.

During operation, the vessel 102 transmits a maritime VHF signal 110 using an AIS transceiver 114 disposed thereon. AIS transceivers are well known in the art, and therefore will not be described in detail herein. The maritime VHF signal 110 consists of a pre-formatted message including a vessel identifier and vessel location information stemming from a Global Positioning System (“GPS”).

In some cases, nefarious operators manipulate the vessel location information to reflect false location information or manipulate the system feeding the AIS system to cause false location information to be reported, i.e., true vessel location information is replaced or transformed to false location information. Accordingly, the nefarious operators report false vessel locations. Current maritime systems have no way of ascertaining whether the reported location information is valid or spoofed. In contrast, system 100 implements a technique to verify whether or not the vessel locations reported via maritime VHF signals 110 are valid. This technique will become evident as the discussion progresses.

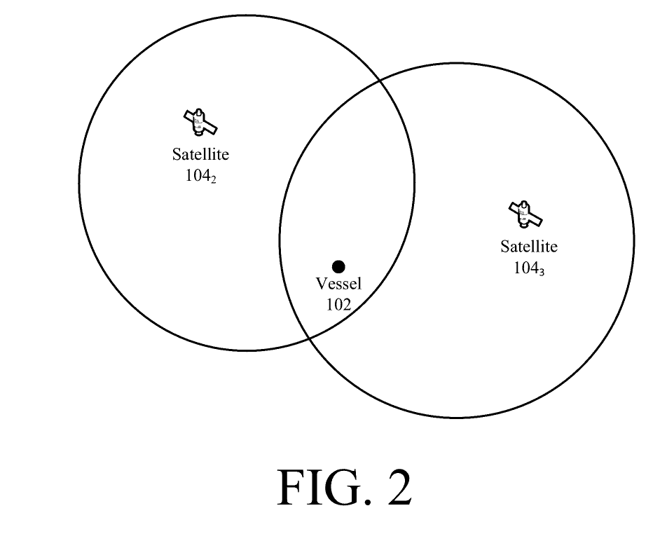

Next, the maritime VHF signal 110 is received by the SBM receivers of two satellites 104₂ and 104₃. In this regard, it should be understood that the vessel 102 is within the FOV of both satellites 104₂ and 104₃, as shown in FIG. 2. The term “Field Of View or (“FOV”)”, as used herein, refers to a coverage area of a satellite or angles through which a satellite is sensitive to maritime signals. At each satellite, the maritime VHF signal 110 is processed to obtain the maritime message 112₁ or 112₂ contained therein (e.g., an AIS message, a DSC message or an ASM message). This signal processing generally involves a direct sampling of the VHF spectra to detect the maritime message. Thereafter, the maritime message is relayed from the satellite to the SPDC 106. In scenarios where the geographic location determinations are to be performed by a ground system, the maritime messages are relayed along with a TOA and/or FOA.

Notably, satellites located above different portions of the Earth (e.g., the western hemisphere and the eastern hemisphere) may communicate the maritime messages to two different SPDCs. The SPDCs are communicatively coupled to each other and/or a central processing unit/database. The TDOA/FDOA processing may be performed by the SPDCs and/or the central processing unit/database.

It should be understood that the satellites can additionally or alternatively perform operations to determine the geographic locations of vessels based on TOA and/or FOA measurement information communicated therebetween, i.e., each satellite may perform the processing of TOA and FOA measurement information generated by itself and at least one other satellite for the purpose of determining a geolocation of a vessel. In this case, the maritime messages may be sent along with the geographic location(s) determined by the satellites for the vessel (rather than or additionally with the TOA and/or FOA measurement information).

Upon receipt of the maritime messages, the SPDC 106 processes the same to obtain the vessel's reported location information, TOAs and/or FOAs therefrom. The TOAs and/or FOAs are used to determine a TDOA and/or an FDOA. The TDOA and/or FDOA are used to validate the vessel location information contained in the maritime messages 112₁ or 112₂. If the vessel information is determined to be invalid, then the SPDC 106 sends a notification to the customer system 108 (e.g., the coast guard's system and/or the navy's system) so that appropriate measures can be taken thereby (e.g., creating a record of false location reporting by vessels that is useful in international courts as evidence of malicious activities thereby, such as drug or human trafficking) The invalidation is achieved by comparing the vessel's reported location information to the vessel's geolocation determined using the TDOAs and/or FDOAs. For example, if the vessel's reported location information does not match the vessel's geolocation, then the vessel's reported location information is considered invalid.

Because satellites 104₂ and 104₃ have different geographic and trigonometric relative positions (i.e., angular positions) to the vessel 102, a difference in arrival times and frequencies of a signal received by the satellites is caused. As noted above, these differences are used to validate where the actual location of the vessel is. The validation is achieved by: computing a calculated vessel position using TDOAs and/or FDOAs; and comparing the calculated vessel position to a reported vessel position. If the calculated vessel position matches or substantially matches the reported vessel position to a certain degree (e.g., within <25 percent degree of difference or within >75 percent degree of similarity with regard to latitude and/or longitude), then the reported vessel position is deemed to be valid. In contrast, if the calculated vessel position does not match or does not substantially match the reported position to a certain degree, then the reported vessel position is deemed to be invalid. In this case, the appropriate authority can be notified. Accordingly, a security threat can be mitigated by validating the data context with coincident signal detections from multiple satellites.

Notably, an Angle Of Arrival (“AOA”) and/or FOA measured by a single satellite does not resolve a vessel's location to the degree of accuracy necessary to either validate or invalidate the vessel's reported position. As such, conventional vessel location techniques (which only consider the AOA and/or FOA obtained by a single satellite) are not suitable for defending against man-in-middle attacks (e.g., vessel location spoofing for reporting a false location). In contrast, the multi-satellite TDOA/TDOA, TDOA/FDOA and/or FDOA/FDOA technique(s) employed herein provides a geolocation means for defending against such man-in-middle attacks.

As evident from the above-discussion, there are many novel features of system 100. These novel features include, but are not limited to, the following: multi-satellite spaced-based maritime VHF anti-spoofing; TDOA/TDOA, TDOA/FDOA, and FDOA/FDOA techniques for geolocation for vessels on or near Earth; and authentication by simultaneous detection from overlapping spatial beams.

Referring now to FIG. 3, there is provided an illustration of an exemplary receiver 300 that is deployed in a satellite (e.g., satellite(s) 104₁, . . . 104_{N} of FIG. 1). Receiver 300 is generally configured to receive, process and report various maritime mobile band channel traffic. The primary channels of interest are the AIS channels, the ASM channels, and the DSC channel(s) (e.g., channel 70).

As shown in FIG. 3, the receiver 300 comprises two antennas, namely an omni-directional antenna 302 and a collinear antenna 304. The receiver 300 also comprises filters 306, 308, a Radio Frequency (“RF”) module 310 and a Low Power Processing Engine (“LPPE”) 312. Components 306-310 collectively perform impedance matching, amplification and filtering to isolate the maritime mobile radio band and ensure adjacent channel VHF energy rejection to at least 60 dBc relative to individual maritime mobile 25 Hz channel communications. This processing is expanded to include the DSC frequency band.

The isolated spectrum is passed to the LPPE 312 for direct Analog-to-Digital (“A/D”) data conversion to generate digitized samples. The digitized samples are then processed to detect, characterize and demodulate a plurality of communication channels (e.g., 6 communication channels) so as to obtain AIS messages, DSC messages and/or ASM messages contained therein. The signal processing generally involves co-channel spatial filtering and actual demodulation of the AIS messages, DSC messages, and/or ASM messages in orbit (e.g., by a satellite). The AIS, DSC and/or ASM messages are then sent from the SBM receiver 300 to a ground based system (e.g., SPDC 106 of FIG. 1), optionally along with TOA measurements, FOA measurements and/or a geographic location determined by the SBM receiver 300 for a vessel.

In some scenarios, the signal processing is entirely performed in firmware of the LPPE 312. In this regard, the LPPE 312 is implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

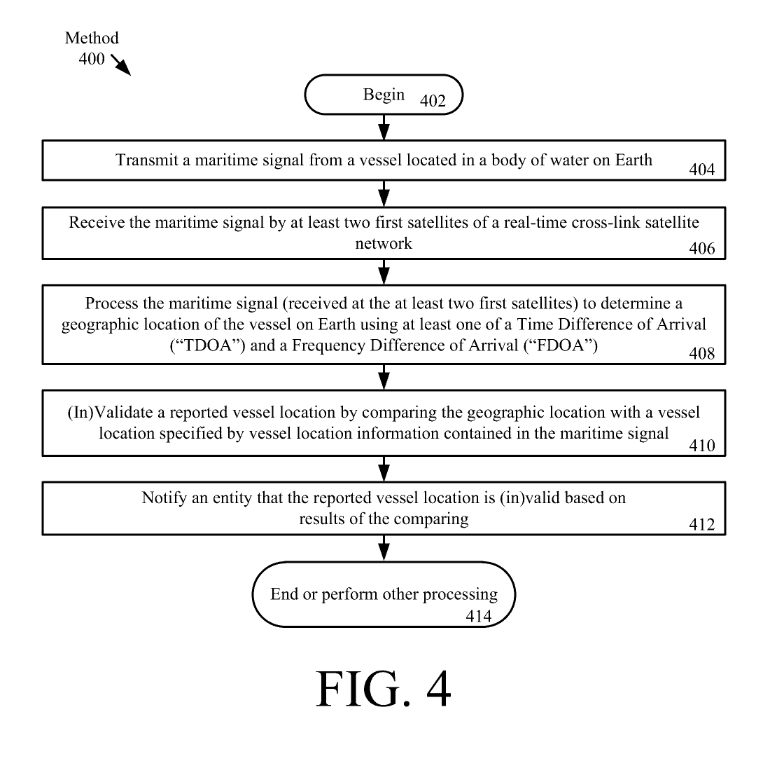

Referring now to FIG. 4, there is provided a flow diagram of an exemplary method 400 for geolocation. Method 400 begins with step 402 and continues with step 404 where a maritime signal is transmitted from a vessel (e.g., vessel 102 of FIG. 1) located in a body of water on Earth. The maritime signal is received in step 406 by at least two first satellites (e.g., satellites 104₂ and 104₃ of FIG. 1) of real-time cross-link satellite network. Next in step 408, the maritime signal is processed to determine a geographic location of the vessel on Earth using at least one of a TDOA and a FDOA.

The term “TDOA”, as used herein, refers to the time difference of arrival of a signal at multiple receiver sites. If the location of the emitter is denoted by u where u=[x,y,z]^{T} and sᵢ=[xᵢ,yᵢ,zᵢ]^{T} denotes the location of the receivers where i=1 . . . N, then the distance between the emitter and the ith receiver can be given by the following mathematical equation (1).

rᵢ=|sᵢ−u|=sqrt((xᵢx)²+(yᵢ−y)²+(zᵢ−z)²) (1)

The TDOA between receivers i and 1 can then be written as follows.

rᵢ,1=c(rᵢ−rᵢ), 1=2 . . . N

where c represents the velocity of propagation in the medium under consideration. An exemplary algorithm that can be used to determine the location of the emitter is described in a document entitled “Geolocation of a known altitude object from TDOA and FDOA measurements” which was written by K. C. Ho and Y. T. Chan and published in IEEE Trans. Aerosp. Elect. Syst., vol. 33, pp. 770-782 in July 1997.

The term “FDOA”, as used herein, refers to the frequency difference of arrival of a signal at multiple receiver sites. If the location of the emitter is denoted by u where u=[x,y,z]^{T} and sᵢ=[xᵢ,yᵢ,zᵢ]^{T} denotes the location of the receivers where i=1 . . . N, then the velocity of the receivers is expressed by the following mathematical equation (2).

s′ᵢ=[xᵢ,yᵢ,zᵢ]^{T} (2)

The set of FDOA measurement equations can be written as follows.

r′i,1=c(rᵢ′−rᵢ′), 1=2 . . . N

An exemplary algorithm that can be used to determine the location of the emitter based on FDOA measurements is also contained in the above referenced document entitled “Geolocation of a known altitude object from TDOA and FDOA measurements”.

Referring again to FIG. 4, a reported vessel location is validated or invalidated, as shown by step 410. The (in)validation is achieved by comparing the geographic location of the vessel with a vessel location specified by vessel location information contained in the maritime signal. Thereafter in step 412, an entity (e.g., coast guard, navy, drug enforcement administration) is notified that the reported vessel location is (in)valid. Subsequently, step 414 is performed where method 400 ends or other processing is performed.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method for space-based geolocation, comprising:
receiving by at least two first satellites a maritime signal transmitted from a vessel on or near Earth at a given time, where the at least two first satellites are deployed in space so as to have overlapping coverage areas and the maritime signal contains information specifying a vessel location; and
processing the maritime signal received at the at least two first satellites to determine a reported vessel location and geographic location of the vessel on Earth using at least one of a Time Difference of Arrival (“TDOA”) determined based on Time Of Arrival (“TOA”) measurements made by the first satellites and a Frequency Difference of Arrival (“FDOA”) determined based on Frequency of Arrival (“FOA”) measurements made by the first satellites.

2. The method according to claim 1, wherein the maritime signal comprises an Automatic Identification System (“AIS”) signal, a Digital Selective Calling (“DSC”) signal, or an Application Specific Messages (“ASM”) signal.

3. The method according to claim 1, further comprising validating or invalidating a reported vessel location by comparing the geographic location with a vessel location specified by vessel location information contained in the maritime signal.

4. The method according to claim 3, wherein the reported vessel location is valid when the geographic location matches the vessel location specified by vessel location information contained in the maritime signal to a first degree, and is invalid when the geographic location does not match the vessel location specified by vessel location information contained in the maritime signal to a second degree.

5. The method according to claim 3, further comprising notifying an entity that the reported vessel location is valid or invalid based on results of the comparing.

6. The method according to claim 1, wherein the geographic location is determined based on a first TDOA measurement for the maritime signal received by the at least two first satellites during a first time period and a second TDOA measurement for the maritime signal received by the at least two first satellites during a second time period.

7. The method according to claim 1, wherein the geographic location is determined based on a first FDOA measurement for the maritime signal received by the at least two first satellites during a first time period and a second FDOA measurement for the maritime signal received by the at least two first satellites during a second time period.

8. The method according to claim 1, wherein the geographic location is determined based on a TDOA measurement for the maritime signal received by the at least two first satellites and a TDOA measurement for the maritime signal received by at least two second satellites.

9. The method according to claim 1, wherein the geographic location is determined based on an FDOA measured for the maritime signal received by the at least two first satellites and an FDOA measurement for the maritime signal received by at least two second satellites.

10. A method for space-based geolocation, comprising:
receiving by at least two first satellites a maritime signal transmitted from a vessel on or near Earth at a given time, where the at least two first satellites are deployed in space so as to have overlapping coverage areas and the maritime signal contains information specifying a vessel location;
processing the maritime signal received at the at least two first satellites to determine a reported vessel location and geographic location of the vessel on Earth using at least one of a Time Difference of Arrival (“TDOA”) determined based on Time Of Arrival (“TOA”) measurements made by the first satellites and a Frequency Difference of Arrival (“FDOA”) determined based on Frequency of Arrival (“FOA”) measurements made by the first satellites; and
validating a reported vessel location by comparing the geographic location with a vessel location specified by vessel location information contained in the maritime signal;
wherein the reported vessel location is valid when the geographic location matches the vessel location specified by vessel location information contained in the maritime signal to a first degree, and is invalid when the geographic location does not match the vessel location specified by vessel location information contained in the maritime signal to a second degree.

11. A system, comprising:
at least two first satellites deployed in space so as to have overlapping coverage areas, whereby the first satellites receive a maritime signal transmitted from a vessel on or near Earth at a given time, the maritime signal containing information specifying a vessel location; and
at least one processor circuit configured to process the maritime signal received at the first satellites to determine a reported vessel location and a geographic location of the vessel on Earth using at least one of a Time Difference of Arrival (“TDOA”) determined based on Time Of Arrival (“TOA”) measurements made by the first satellites and a Frequency Difference of Arrival (“FDOA”) determined based on Frequency of Arrival (“FOA”) measurements made by the first satellites.

12. The system according to claim 11, wherein the maritime signal comprises an Automatic Identification System (“AIS”) signal, a Digital Selective Calling (“DSC”) signal, or an Application Specific Messages (“ASM”) signal.

13. The system according to claim 12, wherein the processor circuit further validates or invalidates a reported vessel location by comparing the geographic location with a vessel location specified by vessel location information contained in the maritime signal.

14. The system according to claim 13, wherein the reported vessel location is valid when the geographic location matches the vessel location specified by vessel location information contained in the maritime signal to a first degree, and is invalid when the geographic location does not match the vessel location specified by vessel location information contained in the maritime signal to a second degree.

15. The system according to claim 13, wherein a business entity is notified that the reported vessel location is valid or invalid based on results of the comparing.

16. The system according to claim 11, wherein the geographic location is determined based on a first TDOA measurement for the maritime signal received by the at least two first satellites during a first time period and a second TDOA measurement for the maritime signal received by the at least two first satellites during a second time period.

17. The system according to claim 11, wherein the geographic location is determined based on a first FDOA measurement for the maritime signal received by the at least two first satellites during a first time period and a second FDOA measurement for the maritime signal received by the at least two first satellites during a second time period.

18. The system according to claim 11, wherein the geographic location is determined based on a TDOA measurement for the maritime signal received by the at least two first satellites and a TDOA measurement for the maritime signal received by at least two second satellites.

19. The system according to claim 11, wherein the geographic location is determined based on an FDOA measured for the maritime signal received by the at least two first satellites and an FDOA measurement for the maritime signal received by at least two second satellites.
